(19) United States
(12) Patent Application Publication
(10) Pub. No.: US 2022/0375014 A1
(43) Pub. Date: Nov. 24, 2022

(54) EVALUATION SYSTEM OF INTELLECTUAL PROPERTY RIGHTS, EVALUATION METHOD OF INTELLECTUAL PROPERTY RIGHTS, EVALUATION PROGRAM, AND CORRECTION DATA

(71) Applicant: HONDA MOTOR CO., LTD., Tokyo (JP)

(72) Inventors: Takio Fukumoto, Tokyo (JP); Takao Shionoya, Tokyo (JP)

(21) Appl. No.: 17/771,260

(22) PCT Filed: Nov. 6, 2019
(86) PCT No.: PCT/JP2019/043452

§ 371 Date: Apr. 22, 2022

(51) Int. Cl. G06Q 50/18; G06N 20/00

(52) U.S. Cl. CPC G06Q 50/184; G06N 20/00

(57) ABSTRACT

An evaluation-data acquisition unit acquires evaluation data on a target intellectual property right which is an intellectual property right to be evaluated. A necessity determination unit determines the necessity of the target intellectual property right on which the evaluation data is acquired by the evaluation-data acquisition unit by using an evaluation model that is generated by machine learning using evaluation data on intellectual property rights and determination results on the necessity of the intellectual property rights as training data and that receives input of evaluation data and outputs necessity determination data indicating the necessity.

### TECHNICAL FIELD

The present invention relates to evaluation systems of intellectual property rights, evaluation methods of intellectual property rights, evaluation programs, and correction data.

### BACKGROUND ART

There have been proposed evaluation apparatuses that determine whether to maintain or discard an intellectual property right by assigning scores to the intellectual property right to be evaluated in terms of a plurality of evaluation items (for example, see Patent Literature 1). The above evaluation apparatus assigns a score for each evaluation item according to a score table in which information set for each evaluation item is associated with scores, and the apparatus, if the total score is larger than a specified value, determines that the intellectual property right is to be maintained and, if the total value is smaller than the specified value, determines that the intellectual property right is to be discarded.

### CITATION LIST

### Patent Literature

[Patent Literature 1]
Japanese Patent Laid-Open No. 2013-41432

### SUMMARY OF INVENTION

### Technical Problem

The above conventional evaluation apparatus assigns scores to an intellectual property right in terms of evaluation items according to a predetermined score table. Since determination of whether to maintain or discard an intellectual property right is dependent on how to set the score table, it is very important to set the score table appropriately. However, the importance and criteria of the evaluation items of intellectual property rights are changing every moment; hence the score table needs to be revised at all times according to changes. However, because there are various evaluation items for intellectual property rights, and the influence between evaluation items and other factors also need to be taken into account, there is an inconvenience that it is difficult to set a score table with which the necessity of intellectual property rights can be determined appropriately.

The present invention has been made in light of the background above, and an object thereof is to provide an evaluation method of intellectual property rights, an evaluation system of intellectual property rights, an evaluation program, and correction data, for determining the necessity of intellectual property rights appropriately.

### Solution to Problem

A first aspect to achieve the above object is an evaluation system of intellectual property rights including: an evaluation-data acquisition unit that acquires evaluation data on a target intellectual property right which is an intellectual property right to be evaluated; an evaluation model generated by machine learning using evaluation data on intellectual property rights and results of determinations on the necessity of the intellectual property rights as training data; and a necessity determination unit that determines, by using the evaluation model, the necessity of the target intellectual property right on which the evaluation data is acquired by the evaluation-data acquisition unit.

The above evaluation system of intellectual property rights may be configured such that the evaluation system further includes an evaluation-model generation unit that generates the evaluation model by machine learning in which determination accuracy for “unnecessary” is prioritized over determination accuracy for “necessary” or machine learning in which determination accuracy for “necessary” is prioritized over determination accuracy for “unnecessary”.

The above evaluation system of intellectual property rights may be configured such the evaluation system of intellectual property rights further includes: a first additional-determination-data acquisition unit that acquires first additional-determination data indicating a necessity determination result by a person in charge on the target intellectual property right determined to be unnecessary by the necessity determination unit; and a first evaluation-model correction unit that, in a case in which the first additional-determination data indicates “necessary”, corrects the evaluation model by machine learning using first correction data as training data, the first correction data including the evaluation data on the target intellectual property right and a determination result that the target intellectual property right is necessary.

The above evaluation system of intellectual property rights may be configured such that in a case in which the first additional-determination data indicates “unnecessary”, the first evaluation-model correction unit corrects the evaluation model by machine learning using the first correction data and second correction data as training data with a larger weight assigned to the first correction data than to the second correction data, the second correction data including the evaluation data on the target intellectual property right and a determination result that the target intellectual property right is unnecessary.

The above evaluation system of intellectual property rights may be configured such that the target intellectual property right is one of a plurality of target intellectual property rights, and the first evaluation-model correction unit repeats correction of the evaluation model until the first additional-determination data on the target intellectual property right determined to be unnecessary by the necessity determination unit satisfies a predetermined condition.

The above evaluation system of intellectual property rights may be configured such that the evaluation system of intellectual property rights further includes: a second additional-determination-data acquisition unit that acquires second additional-determination data indicating a necessity determination result by a person in charge on the target intellectual property right determined to be necessary by the necessity determination unit; and a second evaluation-model correction unit that, in a case in which the second additional-determination data indicates “unnecessary”, corrects the evaluation model by machine learning using third correction data as training data, the third correction data including the evaluation data on the target intellectual property right and a determination result that the target intellectual property right is unnecessary.

The above evaluation system of intellectual property rights may be configured such that in a case in which the second additional-determination data indicates “necessary”, the second evaluation-model correction unit corrects the evaluation model by machine learning using the third correction data and fourth correction data as training data with a larger weight assigned to the third correction data than to the fourth correction data, the fourth correction data including the evaluation data on the target intellectual property right and a determination result that the target intellectual property right is necessary.

The above evaluation system of intellectual property rights may be configured such that the target intellectual property right is one of a plurality of target intellectual property rights, and the second evaluation-model correction unit repeats correction of the evaluation model until the second additional-determination data on the target intellectual property right determined to be necessary by the necessity determination unit satisfies a predetermined condition.

The above evaluation system of intellectual property rights may be configured such that the evaluation system of intellectual property rights further includes: a maintenance-cost calculation unit that calculates the maintenance cost of the intellectual property rights determined to be necessary by the necessity determination unit; and a maintenance-cost examination unit that compares the cost calculated by the maintenance-cost calculation unit with a specified budget.

The above evaluation system of intellectual property rights may be configured such that the evaluation model outputs necessity determination data indicating the confidence level of the necessity along with the necessity of the intellectual property right, and in a case in which the necessity determination unit recognizes that the maintenance cost exceeds the budget as a result of comparison by the maintenance-cost examination unit, the necessity determination unit makes a notification of the target intellectual property rights the confidence levels of which are smaller than or equal to a third specified value, out of the target intellectual property rights determined to be necessary, or the necessity determination unit changes the necessity determination to “unnecessary” from the target intellectual property right having a lower confidence level out of the target intellectual property rights determined to be necessary so that the maintenance cost becomes within the budget.

The above evaluation system of intellectual property rights may be configured such that the evaluation model outputs necessity determination data indicating the confidence level of the necessity along with the necessity of the intellectual property right, and in a case in which the necessity determination unit recognizes that the maintenance cost is below the budget as a result of comparison by the maintenance-cost examination unit, the necessity determination unit makes a notification of the target intellectual property rights the confidence levels of which are smaller than or equal to a fourth specified value, out of the target intellectual property rights determined to be unnecessary, or the necessity determination unit changes the necessity determination to “necessary” from the target intellectual property right having a lower confidence level out of the target intellectual property rights determined to be unnecessary, within a range in which the maintenance cost is lower than or equal to the budget.

The above evaluation system of intellectual property rights may be configured such that the evaluation data includes an evaluation result of an item indicating the importance of the intellectual property right.

The above evaluation system of intellectual property rights may be configured such that the evaluation data includes a budget amount available to hold the intellectual property right.

The above evaluation system of intellectual property rights may be configured such that the evaluation data includes at least one of a technical field to which the intellectual property right belongs, the state of the ownership of the intellectual property right in a plurality of countries, the ownership cost of the intellectual property right, the remaining period of the intellectual property right, whether the intellectual property right has been implemented or not by the owner of the intellectual property right or the possibility of implementing the intellectual property right by the owner of the intellectual property right, and whether the intellectual property right is licensed to others, or the possibility of licensing the intellectual property right to others.

A second aspect to achieve the above object is an evaluation method of intellectual property rights executed by a computer, including: an evaluation-data acquisition step of acquiring evaluation data on a target intellectual property right which is an intellectual property right to be evaluated; and a necessity determination step of determining the necessity of the target intellectual property right on which the evaluation data is acquired in the evaluation-data acquisition step, by using an evaluation model generated by machine learning using evaluation data on intellectual property rights and results of determinations on the necessity of the intellectual property rights as training data.

A third aspect to achieve the above object is an evaluation program for causing a computer to perform functions including: an evaluation-data acquisition unit that acquires evaluation data on a target intellectual property right which is an intellectual property right to be evaluated; an evaluation model generated by machine learning using evaluation data on intellectual property rights and results of determinations on the necessity of the intellectual property rights as training data; and a necessity determination unit that determines, by using the evaluation model, the necessity of the target intellectual property right on which the evaluation data is acquired by the evaluation-data acquisition unit.

A fourth aspect to achieve the above object is correction data used for correction of an evaluation model that is generated by machine learning using evaluation data on intellectual property rights and results of determinations on the necessity of the intellectual property rights as training data and that receives input of the evaluation data and outputs necessity determination data indicating the necessity, the correction data including: evaluation data on a target intellectual property right which is an intellectual property right to be evaluated, the evaluation data being generated in a case in which the evaluation data on the target intellectual property right is input to the evaluation model, the necessity determination data indicating “unnecessary” is output, and a person in charge of intellectual properties determines the target intellectual property right to be necessary; and a determination result that the target intellectual property right is necessary.

### Advantageous Effect of Invention

Since the above evaluation system of intellectual property rights uses an evaluation model generated by machine learning using evaluation data on intellectual property rights and results of determinations on the necessity of the intellectual property rights as training data, it is possible to determine the necessity of intellectual property rights appropriately based on various kinds of evaluation data on intellectual property rights.

### BRIEF DESCRIPTION OF DRAWINGS

FIG. 1 is a diagram for explaining the configuration of an evaluation system of intellectual property rights.

FIG. 2 is a diagram for explaining management data on intellectual property rights.

FIG. 3 is a diagram for explaining a learning phase and an inference phase of an evaluation model.

FIG. 4 is a flowchart of a necessity determination process for a target IP right.

FIG. 5 is a diagram for explaining determination results on the necessity of intellectual property rights by an AI and a person in charge of intellectual properties.

FIG. 6 is a flowchart of correction of necessity determination on intellectual property rights in consideration of a budget and a correction process for an evaluation model.

### DESCRIPTION OF EMBODIMENTS

### 1. Configuration of Evaluation System of Intellectual Property Rights

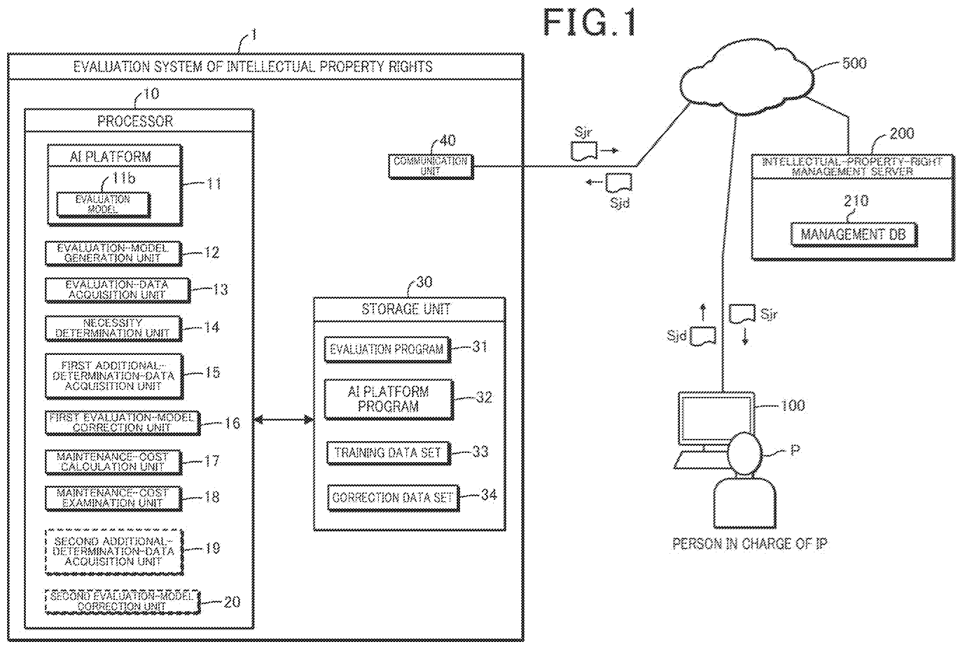

With reference to FIGS. 1 to 3, an evaluation system 1 of intellectual property rights (hereinafter simply referred to as an evaluation system 1) is a computer system including a processor 10, a storage unit 30, and a communication unit 40.

The evaluation system 1 communicates with a terminal 100 for a person in charge of intellectual properties (IP) and an intellectual-property-right management server 200 via a communication network 500 by using the communication unit 40. The terminal 100 for the person in charge of IP is operated by a person P in charge of intellectual properties (IP) who is an expert of intellectual property rights (and who corresponds to the person in charge in the present invention) and presents various kinds of information to the person P in charge of IP.

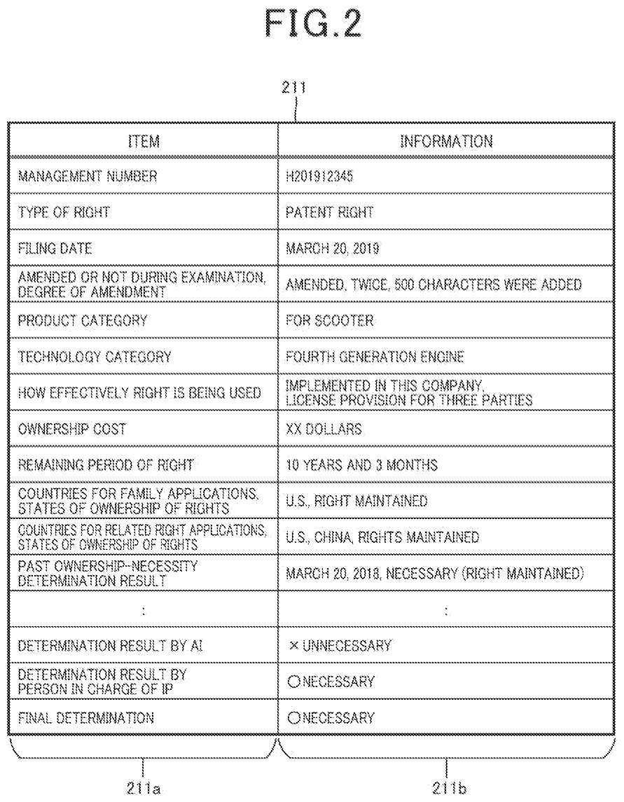

The intellectual-property-right management server 200 includes a management database (DB) 210 that stores management data on intellectual property rights. The management DB 210 stores management data 211 in which items 211a and information 211b on the items 211a are recorded for each intellectual property right as illustrated in FIG. 2. Of the items 211a and the information 211b, the data used for determining the necessity of intellectual property rights corresponds to evaluation data in the present invention.

The items 211a include management number, the type of right (such as patent right, trademark right, or design right), filing date, amended or not during examination and degree of amendment, product category, technology category, how effectively the right is being used, ownership cost, the remaining period of the right, countries for family applications and the states of ownership of rights (right holding countries), countries for related right applications and the states of ownership of rights, and past ownership-necessity determination result. The product category and technology category correspond to the technical field.

Although details will be described later, the items 211a include the necessity determination result and the confidence level of the necessity determination by AI (an evaluation model 11b described later), the necessity determination result by the person P in charge of IP, and the final determination on the necessity. Besides the items illustrated in FIG. 2, evaluation results of the items indicating the importance of the intellectual property right (determined by the person P in charge of IP, an engineer in charge, a marketing person in charge, external evaluation agencies, and the like) and the budget available for acquiring and holding the intellectual property right, and the like may be included.

Here, in the case in which the intellectual property right is a patent right for example, the factors used for evaluation of the items indicating the importance of the intellectual property right include an evaluation rank set by the applicant, the number of citations (the number of times cited as conventional techniques in the course of examination of other patent applications at major intellectual property offices), whether the invention has been implemented or not, the degree of possibility of implementing the invention, the possibility of licensing to others, in terms of the level of technology related the invention of the patent right, the degree of relevance to the technology trend, and others.

The storage unit 30 stores an evaluation program 31 for implementing the process of the evaluation system 1, an AI platform program 32 that makes the processor 10 function as an artificial intelligence (AI) platform 11, a training data set 33 used for machine learning of the AI platform, and a correction data set 34 for correcting an evaluation model 11b of the intellectual property rights generated by the machine learning. The AI platform 11 is a platform in which a pre-trained model is prepared for the AI having a neural network structure.

The processor 10 reads and executes the evaluation program 31 stored in the storage unit 30 to function as an evaluation-model generation unit 12, an evaluation-data acquisition unit 13, a necessity determination unit 14, a first additional-determination-data acquisition unit 15, a first evaluation-model correction unit 16, a maintenance-cost calculation unit 17, a maintenance-cost examination unit 18, a second additional-determination-data acquisition unit 19, and a second evaluation-model correction unit 20. The second additional-determination-data acquisition unit 19 and the second evaluation-model correction unit 20 are used in another embodiment described later.

Here, the process executed by the evaluation-data acquisition unit 13 corresponds to the evaluation data obtaining step in an evaluation method of intellectual property rights of the present invention. The process executed by the necessity determination unit 14 corresponds to the necessity determination step in the evaluation method of intellectual property rights of the present invention.

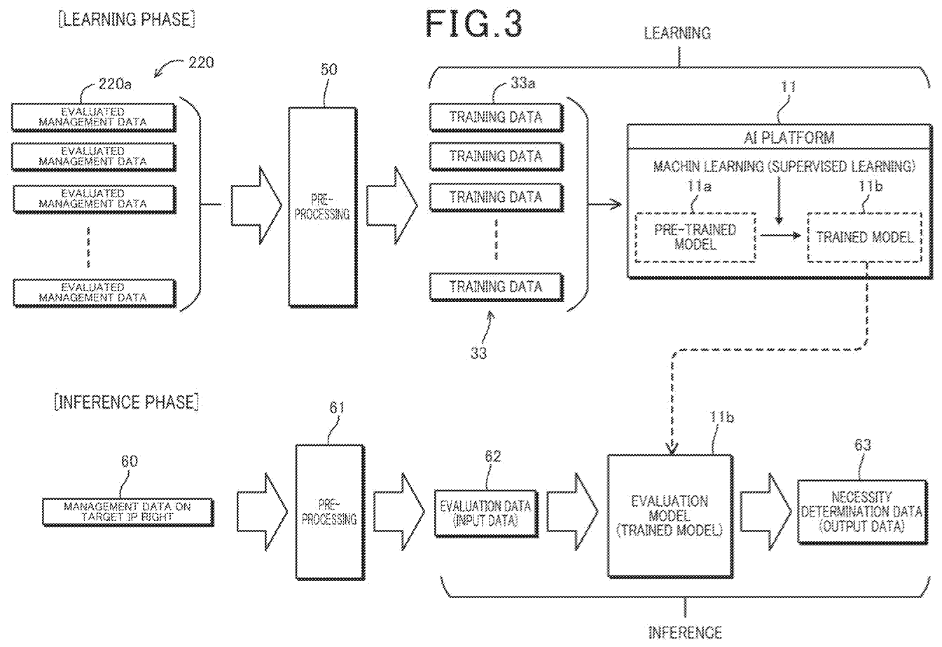

The evaluation-model generation unit 12, as shown in the learning phase in FIG. 3, generates the training data set 33 by performing a pretreatment 50 for extracting the items used for necessity determination on a set 220 of management data 220a in which the necessity of intellectual property rights has been evaluated by the person P in charge of IP, out of the management data on the intellectual property rights stored in the management DB 210.

The items used for the necessity determination are selected as appropriate out of the items of the management data illustrated in FIG. 2. For example, if product category, technology category, ownership cost, and countries at which the rights are held for the family applications are selected as the items used for the necessity determination, the necessity of an intellectual property right can be determined in consideration of ownership cost for each country in which the intellectual property right is implemented in products or technologies.

The training data set 33 is a set of training data 33a in which the evaluation data indicating the information on the items is associated with the determination on the necessity (necessary/unnecessary) by the person P in charge of IP. The evaluation-model generation unit 12 inputs the training data set 33 to a pre-trained model 11a prepared in the AI platform 11 to train it by machine learning and thereby generates the evaluation model 11b for determining the necessity of intellectual property rights as a trained model. The evaluation model 11b, as illustrated in the inference phase in FIG. 3, receives input of evaluation data 62 on a target IP right (a target intellectual property right to be evaluated) and outputs necessity determination data 63 indicating that the target IP is necessary or unnecessary.

Specifications of the machine learning by the evaluation-model generation unit 12 can be selected depending on whether maintaining intellectual property rights is prioritized, or reduction of the ownership cost of intellectual property rights is prioritized. In the case of prioritizing maintaining intellectual property rights, the evaluation-model generation unit 12 generates an evaluation model 11b by machine learning in which determination accuracy for “unnecessary” is prioritized over determination accuracy for “necessary”. This makes it possible to reduce the possibility that an intellectual property right that would be determined to be necessary by the person P in charge of IP is determined to be unnecessary as erroneously determined by the evaluation model 11b. This reduces the number of intellectual property rights that are determined to be unnecessary by the evaluation model 11b and then are additionally determined by the person P in charge of IP, and this in turn reduces a burden on the person P in charge of IP.

In the case of prioritizing reduction of the ownership cost of intellectual property rights, the evaluation-model generation unit 12 generates an evaluation model 11b by machine learning in which determination accuracy for “necessary” is prioritized over determination accuracy for “unnecessary”. This makes it possible to reduce the possibility that an intellectual property right that would be determined to be unnecessary by the person P in charge of IP is determined to be necessary as erroneously determined by the evaluation model 11b. This reduces the number of intellectual property rights that are determined to be necessary by the evaluation model 11b and then are additionally determined by the person P in charge of IP, and this in turn reduces a burden on the person P in charge of IP.

Which is prioritized in machine learning, determination accuracy for “unnecessary” or determination accuracy for “necessary”, is set by selection of the management data items in the pretreatment of training data, change of the weight of each item in the training data, change of the weighting factor of each item in the training data input to the evaluation model 11b, or the like.

The evaluation-data acquisition unit 13 acquires evaluation data on a target IP right by receiving it from the intellectual-property-right management server 200, the terminal 100 for the person in charge of IP, or the like. The evaluation-data acquisition unit 13 may directly acquire the evaluation data on the target IP right, or, as illustrated in the inference phase in FIG. 3, may generate the evaluation data 62 by performing a pretreatment 61 on management data 60 on the target IP right, such as extraction of data on the items used for evaluation and weighting of the items.

The necessity determination unit 14, as illustrated in the inference phase in FIG. 3, inputs the evaluation data 62 acquired by the evaluation-data acquisition unit 13 into the evaluation model 11b and determines the necessity of the target IP right based on the necessity determination data 63 output from the evaluation model 11b. The functions of the first additional-determination-data acquisition unit 15, the first evaluation-model correction unit 16, the maintenance-cost calculation unit 17, and the maintenance-cost examination unit 18 will be described when a necessity determination process, a necessity-determination correction process, or an evaluation-model correction process are described later.

### 2. Necessity Determination Process for Target IP Right

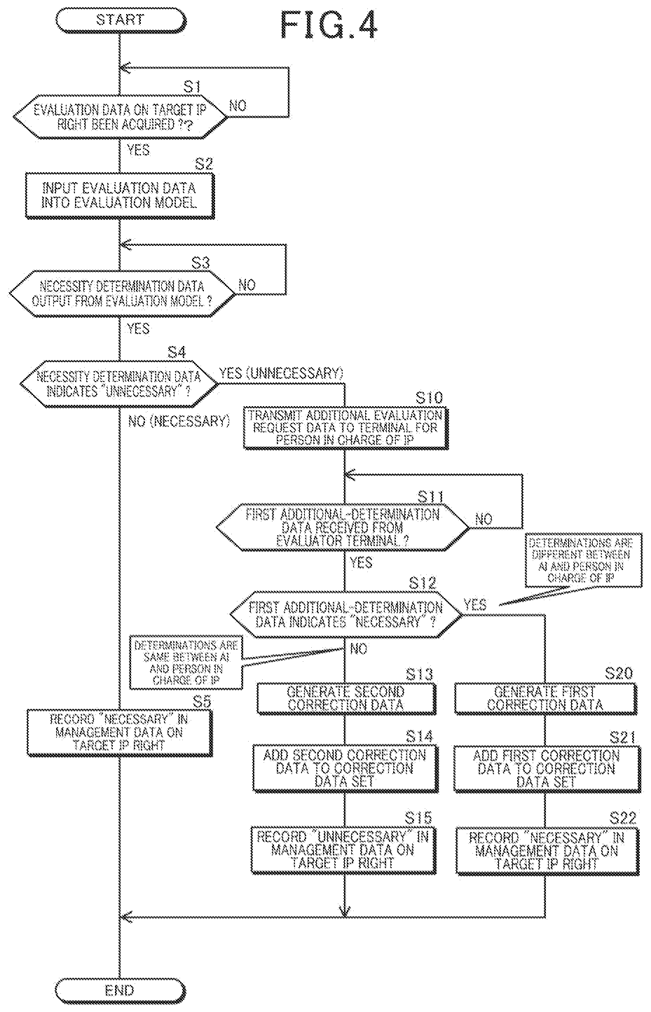

The necessity determination process for a target IP right will be described based on the flowchart illustrated in FIG. 4. The necessity determination process for target IP rights is performed at specified intervals (for example, once a year, twice a year, or the like) on management data on each intellectual property right stored in the management DB 210.

In step S1 in FIG. 4, when the evaluation-data acquisition unit 13 has acquired the evaluation data on a target IP right, the process proceeds to step S2. In step S2, the necessity determination unit 14 inputs the evaluation data into the evaluation model 11b, and in the next step S3, when the evaluation model 11b has output necessity determination data, the process proceeds to step S4. In step S4, the necessity determination unit 14 determines whether the necessity determination data indicates “unnecessary”.

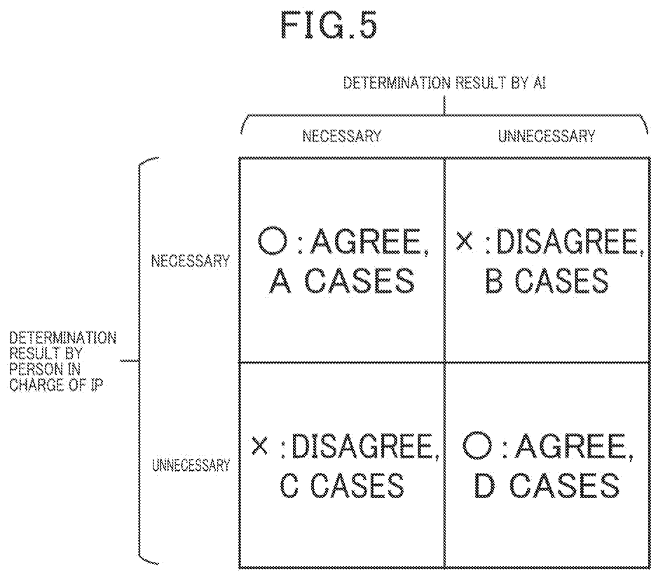

Here is shown in FIG. 5 a verification example about the necessity determination on target IP rights in which the determination results by the AI (the determination results by the evaluation model 11b) and the determination results by the person P in charge of IP are compared. There are A IP rights that were determined to be necessary by both the AI and the person P in charge of IP, and D IP rights that were determined to be unnecessary by both the AI and the person P in charge of IP.

There are C IP rights that were determined to be necessary by the AI and determined to be unnecessary by the person P in charge of IP, and B IP rights that were determined to be unnecessary by the AI and determined to be necessary by the person P in charge of IP. Regarding the IP rights that were determined differently by the AI and the person P in charge of IP as above, the person P in charge of IP makes additional determination on the IP rights determined to be unnecessary by the AI in the present embodiment; thereby the situation of reaching a conclusion that the intellectual property rights that should be maintained are unnecessary as erroneously determined by the AI is avoided. In addition, regarding the IP rights that were determined to be unnecessary by the AI and determined to be necessary by the person P in charge of IP, a process is executed to make a correction on the evaluation model 11b so that the AI will determine them to be necessary.

Here, there is a possibility that IP rights determined to be necessary by the AI may be determined to be unnecessary by the person P in charge of IP, but additional determination is not performed on them by the person P in charge of IP because reduction of the work time of the person P in charge of IP used for the necessity determination is prioritized in the present embodiment. In contrast, for the IP rights determined to be unnecessary by the AI, there is a possibility of losing intellectual property rights as erroneously determined by the AI, and thus the person P in charge of IP performs additional determination because the ownership of intellectual property rights is prioritized in the present embodiment. Note that in the case in which reduction of the ownership cost of intellectual property rights is prioritized, contrary to the above action, the person P in charge of IP makes additional determination on the IP rights determined to be necessary by the AI, instead of making additional determination by the person P in charge of IP on the IP rights determined to be unnecessary by the AI.

In step S4, the necessity determination unit 14, if the necessity determination data indicates “unnecessary”, advances the process to step S10, and, if the necessity determination data indicates “necessary”, advances the process to step S5. In step S5, the necessity determination unit 14 records “necessary” in the items “determination result by AI” and “final determination” of the management data on the target IP right (see FIG. 2).

In step S10, the first additional-determination-data acquisition unit 15 transmits additional-determination request information Sjr for requesting an additional necessity determination on the target IP right by the person P in charge of IP, to the terminal 100 for the person in charge of IP (see FIG. 1). Having received the additional-determination request information Sjr, the terminal 100 for the person in charge of IP receives the management data on the target IP right from the intellectual-property-right management server 200 and displays the evaluation data on the target IP right on the display. The person P in charge of IP checks the evaluation data on the target IP right and makes a determination on the necessity of the target IP right, and transmits first additional-determination data Sjd indicating that the target IP right is necessary or unnecessary, to the evaluation system 1.

When the first additional-determination-data acquisition unit 15 has received the first additional-determination data Sjd from the terminal 100 for the person in charge of IP in step S11, the process proceeds to step S12. In step S12, the first evaluation-model correction unit 16 determines whether the first additional-determination data Sjd indicates “necessary” or not. The first evaluation-model correction unit 16, if the first additional-determination data Sjd indicates “necessary”, advances the process to step S20, and, if the first additional-determination data Sjd indicates “unnecessary”, advances the process to step S13.

In step S20, the first evaluation-model correction unit 16 generates first correction data including the evaluation data on the target IP right and the determination of “necessary”. The first correction data is data in which the determination of “unnecessary” by the AI is corrected to the determination of “necessary” by the person P in charge of IP. In the following step S21, the first evaluation-model correction unit 16 adds the first correction data to the correction data set 34. In the following step S22, the first evaluation-model correction unit 16 records “unnecessary” in the item “determination result by AI” of the management data on the target IP right, records “necessary” in the item “determination result by person in charge of IP”, and records “necessary” in the item “final determination”.

In step S13, the first additional-determination-data acquisition unit 15 generates second correction data including the evaluation data on the target IP right and the determination result of “unnecessary”. The second correction data is data in which the determination of “unnecessary” by the AI and the person P in charge of IP is used as it is. In the following step S14, the first additional-determination-data acquisition unit 15 adds the second correction data to the correction data set 34. In the following step S15, the first additional-determination-data acquisition unit 15 records “unnecessary” in the items “determination result by AI”, “determination result by person in charge of IP”, and “final determination” of the management data on the target IP right.

### 3. Correction of Necessity Determination on Intellectual Property Rights in Consideration of Budget, and Correction Process for Evaluation Model

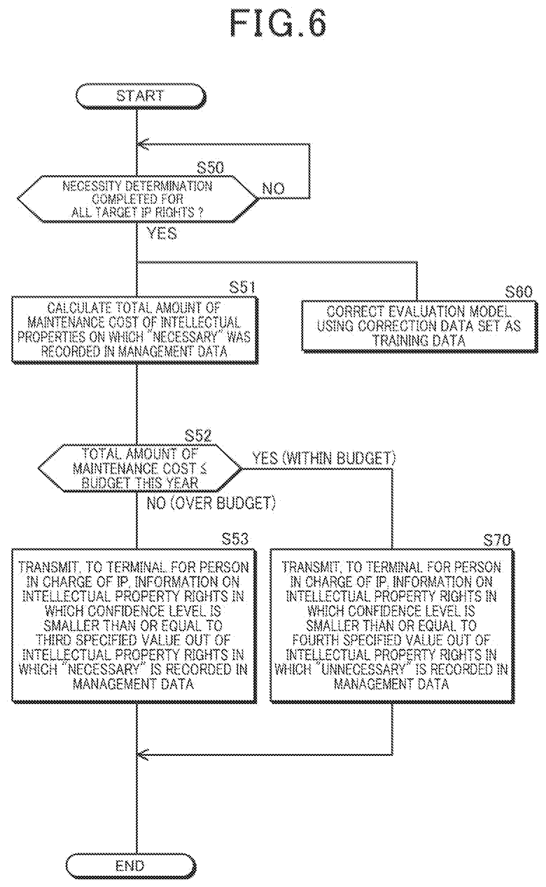

A description will be given of correction of intellectual property rights in consideration of a specified budget and a correction process for the evaluation model, based on the flowchart illustrated in FIG. 6.

In step S50 in FIG. 6, when the necessity determination process illustrated in FIG. 4 is completed for all the target IP rights on which the management data is stored in the management DB 210, the necessity determination unit 14 advances the process to step S51 and step S60. In step S60, the first evaluation-model correction unit 16 corrects the evaluation model 11b by training the evaluation model 11b by machine learning using the correction data set 34 as the training data.

In this case, in the case in which the correction data set 34 includes the first correction data and the second correction data, machine learning is performed with a larger weight assigned to the first correction data corrected to the determination result by the person P in charge of IP than to the second correction data, and it is thereby possible to correct the evaluation model 11b such that that the evaluation model 11b reflects the correction of the determination result by the person in charge of IP more. Alternatively, the evaluation model 11b may be corrected by performing reinforcement learning with the reward of the first correction data set larger than that of the second correction data.

In this process, the first evaluation-model correction unit 16 may repeat correction of the evaluation model 11b until the ratio of the intellectual property rights determined to be “necessary” by the additional determination by the person P in charge of IP out of the intellectual property rights determined to be “unnecessary” by the AI becomes smaller than or equal to a first specified value. Alternatively, the process for the evaluation model 11b may be repeated until the number of intellectual property rights determined to be “unnecessary” by the AI and determined to be “necessary” by additional determination by the person P in charge of IP becomes lower than or equal to a specified number (for example, 0). In this case, the condition that the ratio of the intellectual property rights determined to be “necessary” by additional determination by the person P in charge of IP out of the intellectual property rights determined to be “unnecessary” by the AI becomes smaller than or equal to the first specified value and the condition that the number of intellectual property rights determined to be “unnecessary” by the AI and determined to be “necessary” by additional determination by the person P in charge of IP becomes lower than or equal to a specified number correspond to predetermined specified conditions in the present invention.

In step S51, the maintenance-cost calculation unit 17 calculates the total amount of the maintenance cost (cost such as yearly maintenance fees) for the intellectual property rights in which “necessary” is recorded in the item “final determination” of the management data. In the following step S52, the maintenance-cost examination unit 18 determines whether the total amount of the maintenance cost is smaller than or equal to a specified budget. If the maintenance-cost examination unit 18 recognizes that the total amount of the maintenance cost is smaller than or equal to the budget (below the budget), the process proceeds to step S70. In step S70, the necessity determination unit 14 transmits, to the terminal 100 for the person in charge of IP, information on the intellectual property rights in which the confidence level of the determination of “unnecessary” is smaller than or equal to a fourth specified value out of the intellectual property rights in which “unnecessary” is recorded in the item “determination result by AI” of the management data.

The terminal 100 for the person in charge of IP displays information on the intellectual property rights in which the confidence level of the determination of “unnecessary” is smaller than or equal to the fourth specified value on the display, and the person P in charge of IP, by checking this display, can reexamine maintenance of the intellectual property rights that were determined to be “unnecessary”, within the range of the budget.

In step S52, in the case in which the maintenance-cost examination unit 18 recognizes that the total amount of the maintenance cost exceeds the specified budget limit (over the budget), the process proceeds to step S53. In step S53, the necessity determination unit 14 transmits, to the terminal 100 for the person in charge of IP, information on the intellectual property rights in which the confidence level of the determination of “necessary” is smaller than or equal to a third specified value out of the intellectual property rights in which “necessary” is recorded in the item “determination result by AI” of the management data.

The terminal 100 for the person in charge of IP displays information on the intellectual property rights in which the confidence level of the determination of “necessary” is smaller than or equal to the third specified value on the display, and the person P in charge of IP, by checking this display, can reexamine maintenance of the intellectual property rights that were determined to be “necessary” so that the maintenance cost can be within the budget limit. Here, displaying on the display corresponds to the notification in the present invention.

### 4. Other Embodiments

In the above embodiment, the first additional-determination-data acquisition unit 15 requests additional determination by the person P in charge of IP on the target IP rights determined to be “unnecessary” by the AI (the evaluation model 11b). In addition, the first evaluation-model correction unit 16 corrects the evaluation model 11b by machine learning using the first and second correction data reflecting the additional determination result as training data.

Another possible configuration may include the second additional-determination-data acquisition unit 19 (see FIG. 1) that requests additional determination by the person P in charge of IP on the target IP rights determined to be “necessary” by the AI and the second evaluation-model correction unit 20 (see FIG. 1) that corrects the evaluation model 11b by machine learning using third and fourth correction data reflecting the additional determination result as training data. Here, the third correction data is data including the evaluation data on a target IP right determined to be “necessary” by the AI and determined to be “unnecessary” by the person in charge of IP and the determination of “unnecessary”, and the fourth correction data is data including the evaluation data on a target IP right determined to be “necessary” by the AI and the person P in charge of IP and the determination of “necessary”.

Correction of the evaluation model 11b by the second evaluation-model correction unit 20 may be performed with a larger weight assigned to the third correction data than to the fourth correction data. The evaluation model 11b may be corrected until the ratio of the target IP rights determined to be “unnecessary” by additional determination by the person P in charge of IP out of the target IP rights determined to be “necessary” by the AI becomes smaller than or equal to a second specified value. The evaluation model 11b may be corrected by using only the third correction data.

Although the above embodiment includes the maintenance-cost calculation unit 17 and the maintenance-cost examination unit 18, and the necessity of the intellectual property rights determined to be “necessary” or “unnecessary” is reexamine according to the budget limit based on the confidence level of the necessity determination, a configuration without the maintenance-cost calculation unit 17 and the maintenance-cost examination unit 18 is possible.

Although in the above embodiment, the first evaluation-model correction unit 16 generates the correction data set 34 with the first correction data and the second correction data weighted through the process according to the flowchart illustrated in FIG. 4, the correction data set 34 may be generated without weighting. Alternatively, the correction data set 34 may be generated by using only the first correction data.

In the above embodiment, the necessity determination unit 14, in step S53 in FIG. 6, transmits, to the terminal 100 for the person in charge of IP, information on the intellectual property rights in which the confidence level of the determination of “necessary” by the AI is smaller than or equal to the third specified value out of the target IP rights in which “necessary” is recorded in the item “final determination” of the management data. As another configuration, out of the target IP rights in which “necessary” is recorded in the item “final determination” of the management data, the record in the item “final determination” may be changed from “necessary” to “unnecessary” from the IP right for which the confidence level of the determination of “necessary” by the AI is the lowest within a range in which the total amount of the maintenance cost does not exceeds the budget.

In the above embodiment, the necessity determination unit 14, in step S70 in FIG. 6, transmits, to the terminal 100 for the person in charge of IP, information on the intellectual property rights in which the confidence level of the determination of “unnecessary” by the AI is smaller than or equal to the fourth specified value out of the target IP rights in which “unnecessary” is recorded in the item “final determination” of the management data. As another possible configuration, out of the target IP rights in which “unnecessary” is recorded in the item “final determination” of the management data, the record in the item “final determination” may be changed from “unnecessary” to “necessary” from the IP right for which the confidence level of the determination of “unnecessary” by the AI is the lowest within a range in which the total amount of the maintenance cost does not exceeds the budget.

Although the above embodiment shows a case in which the necessity of payment of the maintenance cost of the intellectual property rights is determined as an example of determination on the necessity regarding intellectual property rights, the present invention is also applicable to the necessity of applications of intellectual property rights, the necessity of applications of intellectual property rights to other countries, the necessity of requests for examination for intellectual property rights, and the like.

Note that FIG. 1 is a schematic diagram illustrating the functional configuration of the evaluation system 1 of intellectual property rights divided based on the main processes to make it easy to understand the invention of the present application; hence the configuration of the evaluation system 1 of intellectual property rights may be divided in another way. The processes of the constituents may be executed by one hardware unit or may be executed by a plurality of hardware units. The processes of the constituents illustrated in FIGS. 4 and 6 may be executed by one program or may be executed by a plurality of programs.

### 5. Configurations Supported by Above Embodiments

The above embodiments are specific examples of the following configurations.

(First Item) An evaluation system of intellectual property rights including: an evaluation-data acquisition unit that acquires evaluation data on a target intellectual property right which is an intellectual property right to be evaluated; an evaluation model generated by machine learning using evaluation data on intellectual property rights and results of determinations on the necessity of the intellectual property rights as training data; and a necessity determination unit that determines, by using the evaluation model, the necessity of the target intellectual property right on which the evaluation data is acquired by the evaluation-data acquisition unit.

Since the evaluation system of intellectual property rights according to the first item uses the evaluation model generated by machine learning using evaluation data on intellectual property rights and results of determinations on the necessity of the intellectual property rights as training data, it is possible to determine the necessity of intellectual property rights appropriately based on various kinds of evaluation data on the intellectual property rights.

(Second Item) The evaluation system of intellectual property rights according to the first item, further including an evaluation-model generation unit that generates the evaluation model by machine learning in which determination accuracy for “unnecessary” is prioritized over determination accuracy for “necessary” or machine learning in which determination accuracy for “necessary” is prioritized over determination accuracy for “unnecessary”.

Since in the evaluation system of intellectual property rights according to the second item, in the case of prioritizing maintenance of intellectual property rights, the evaluation model is generated by machine learning in which determination accuracy for “unnecessary” is prioritized over determination accuracy for “necessary”, it is possible to reduce the possibility that target intellectual property rights that would be determined to be necessary by a person in charge are determined to be unnecessary by misdetermination. This can reduce a burden of additional determination on the person in charge on the target intellectual property rights determined to be unnecessary.

Since in the case of prioritizing reduction of the ownership cost of intellectual property rights, the evaluation model is generated by machine learning in which the determination accuracy for “necessary” is prioritized over the determination accuracy for “unnecessary”, it is possible to reduce the possibility that target intellectual property rights that would be determined to be unnecessary by a person in charge are determined to be necessary by misdetermination. This can reduce a burden of additional determination on the person in charge on the target intellectual property rights determined to be necessary.

(Third Item) The evaluation system of intellectual property rights according to the first item, further including: a first additional-determination-data acquisition unit that acquires first additional-determination data indicating a necessity determination result by a person in charge on the target intellectual property right determined to be unnecessary by the necessity determination unit; and a first evaluation-model correction unit that, in a case in which the first additional-determination data indicates “necessary”, corrects the evaluation model by machine learning using first correction data as training data, the first correction data including the evaluation data on the target intellectual property right and a determination result that the target intellectual property right is necessary.

In the evaluation system of intellectual property rights according to the third item, in the case in which a target intellectual property right is determined to be unnecessary by the necessity determination unit and determined to be necessary by the person in charge of IP, the evaluation model is corrected by machine learning using the first correction data, and thus it is possible to improve accuracy in the necessity determination by the evaluation model.

(Fourth Item) The evaluation system of intellectual property rights according to the second item, in which in a case in which the first additional-determination data indicates “unnecessary”, the first evaluation-model correction unit corrects the evaluation model by machine learning using the first correction data and second correction data as training data with a larger weight assigned to the first correction data than to the second correction data, the second correction data including the evaluation data on the target intellectual property right and a determination result that the target intellectual property right is unnecessary.

In the evaluation system of intellectual property rights according to the fourth item, it is possible to correct the evaluation model more effectively by assigning a larger weight to the first correction data in which the determination by the necessity determination unit is corrected by the determination by a person in charge of IP than to the second correction data, regarding the first correction data and the second correction data reflecting the necessity determination result by the person in charge of IP.

(Fifth Item) The evaluation system of intellectual property rights according to the second or third item, in which the target intellectual property right is one of a plurality of target intellectual property rights, and the first evaluation-model correction unit repeats correction of the evaluation model until the first additional-determination data on the target intellectual property right determined to be unnecessary by the necessity determination unit satisfies a predetermined condition.

The evaluation system of intellectual property rights according to the fifth item can improve, stepwise, accuracy in the necessity determination by the evaluation system of intellectual property rights.

(Sixth Item) The evaluation system of intellectual property rights according to any one of the first to fourth items, further including: a second additional-determination-data acquisition unit that acquires second additional-determination data indicating a necessity determination result by a person in charge on the target intellectual property right determined to be necessary by the necessity determination unit; and a second evaluation-model correction unit that, in a case in which the second additional-determination data indicates “unnecessary”, corrects the evaluation model by machine learning using third correction data as training data, the third correction data including the evaluation data on the target intellectual property right and a determination result that the target intellectual property right is unnecessary.

In the evaluation system of intellectual property rights according to the sixth item, in the case in which a target intellectual property right is determined to be necessary by the necessity determination unit and determined to be necessary by the person in charge of IP, the evaluation model is corrected by machine learning using the third correction data, and thus it is possible to improve accuracy in the necessity determination by the evaluation model.

(Seventh Item) The evaluation system of intellectual property rights according to the fifth item, in which in a case in which the second additional-determination data indicates “necessary”, the second evaluation-model correction unit corrects the evaluation model by machine learning using the third correction data and fourth correction data as training data with a larger weight assigned to the third correction data than to the fourth correction data, the fourth correction data including the evaluation data on the target intellectual property right and a determination result that the target intellectual property right is necessary.

In the evaluation system of intellectual property rights according to the seventh item, it is possible to correct the evaluation model more effectively by assigning a larger weight to the third correction data in which the determination by the necessity determination unit is corrected by the determination by a person in charge of IP than to the fourth correction data, regarding the third correction data and the fourth correction data reflecting the necessity determination result by the person in charge of IP.

(Eighth Item) The evaluation system of intellectual property rights according to the fifth or sixth item, in which the target intellectual property right is one of a plurality of target intellectual property rights, and the second evaluation-model correction unit repeats correction of the evaluation model until the second additional-determination data on the target intellectual property right determined to be necessary by the necessity determination unit satisfies a predetermined condition.

The evaluation system of intellectual property rights according to the eighth item can improve, stepwise, accuracy in the necessity determination by the evaluation system of intellectual property rights.

(Ninth item) The evaluation system of intellectual property rights according to any one of the first to seventh items, further including: a maintenance-cost calculation unit that calculates the maintenance cost of the intellectual property rights determined to be necessary by the necessity determination unit; and a maintenance-cost examination unit that compares the cost calculated by the maintenance-cost calculation unit with a specified budget.

With the evaluation system of intellectual property rights according to the ninth item, it is possible to determine the necessity of intellectual property rights in consideration of the maintenance cost of the intellectual property rights and the budget.

(Tenth Item) The evaluation system of intellectual property rights according to the eighth item, in which the evaluation model outputs necessity determination data indicating the confidence level of the necessity along with the necessity of the intellectual property right, and in a case in which the necessity determination unit recognizes that the maintenance cost exceeds the budget as a result of comparison by the maintenance-cost examination unit, the necessity determination unit makes a notification of the target intellectual property rights the confidence levels of which are smaller than or equal to a third specified value, out of the target intellectual property rights determined to be necessary, or the necessity determination unit changes the necessity determination to “unnecessary” from the target intellectual property right having a lower confidence level out of the target intellectual property rights determined to be necessary so that the maintenance cost becomes within the budget.

With the evaluation system of intellectual property rights according to the tenth item, in the case in which the maintenance cost of the intellectual property rights exceeds the budget, it is possible to promote squeeze of the maintenance cost into the budget by making a notification of the target intellectual property rights on which the confidence level of the determination of “necessary” is low or changing the necessity determination of the intellectual property rights on which the confidence level of the determination of “necessary” is low to “unnecessary”.

(Eleventh Item) The evaluation system of intellectual property rights according to the eighth or ninth item, in which the evaluation model outputs necessity determination data indicating the confidence level of the necessity along with the necessity of the intellectual property right, and in a case in which the necessity determination unit recognizes that the maintenance cost is below the budget as a result of comparison by the maintenance-cost examination unit, the necessity determination unit makes a notification of the target intellectual property rights the confidence levels of which are smaller than or equal to a fourth specified value, out of the target intellectual property rights determined to be unnecessary, or the necessity determination unit changes the necessity determination to “necessary” from the target intellectual property right having a lower confidence level out of the target intellectual property rights determined to be unnecessary, within a range in which the maintenance cost is lower than or equal to the budget.

With the evaluation system of intellectual property rights according to the eleventh item, in the case in which the maintenance cost of the intellectual property rights is below the budget, it is possible to promote increase of the intellectual property rights determined to be necessary within a range of the budget by making a notification of the target intellectual property rights on which the confidence level of the determination of “unnecessary” is low or changing the necessity determination of the intellectual property rights on which the confidence level of the determination of “unnecessary” is low to “necessary”.

(Twelfth Item) The evaluation system of intellectual property rights according to any one of the first to tenth items, in which the evaluation data includes an evaluation result of an item indicating the importance of the intellectual property right.

Since the evaluation system of intellectual property rights according to the twelfth item uses an evaluation result of an item indicating the importance of the intellectual property right as evaluation data, it is possible to determine efficiently the intellectual property rights having higher importance to be necessary.

(Thirteenth Item) The evaluation system of intellectual property rights according to any one of the first to eleventh items, in which the evaluation data includes a budget amount available to hold the intellectual property right.

With the evaluation system of intellectual property rights according to the Thirteenth item, it is possible to determine the necessity of intellectual property rights based on the state of the set budget amount.

(Fourteenth Item) The evaluation system of intellectual property rights according to any one of the first to twelfth items, in which the evaluation data includes at least one of a technical field to which the intellectual property right belongs, the state of the ownership of the intellectual property right in a plurality of countries, the ownership cost of the intellectual property right, the remaining period of the intellectual property right, whether the intellectual property right has been implemented or not by the owner of the intellectual property right or the possibility of implementing the intellectual property right by the owner of the intellectual property right, and whether the intellectual property right is licensed to others, or the possibility of licensing the intellectual property right to others.

Since in the evaluation system of intellectual property rights according to the fourteenth item, the evaluation data includes at least one of a technical field to which the intellectual property right belongs, the state of the ownership of the intellectual property right in a plurality of countries, the ownership cost of the intellectual property right, the remaining period of the intellectual property right, whether the intellectual property right has been implemented or not by the owner of the intellectual property right or the possibility of implementing the intellectual property right by the owner of the intellectual property right, and whether the intellectual property right is licensed to others, or the possibility of licensing the intellectual property right to others, which are important factors to determine the necessity of an intellectual property right, it is possible to increase accuracy in necessity determination on intellectual property rights.

(Fifteenth Item) An evaluation method of intellectual property rights executed by a computer, including: an evaluation-data acquisition step of acquiring evaluation data on a target intellectual property right which is an intellectual property right to be evaluated; and a necessity determination step of determining the necessity of the target intellectual property right on which the evaluation data is acquired in the evaluation-data acquisition step, by using an evaluation model generated by machine learning using evaluation data on intellectual property rights and results of determinations on the necessity of the intellectual property rights as training data.

Since the evaluation method of intellectual property rights according to the fifteenth item uses the evaluation model generated by machine learning using evaluation data on intellectual property rights and results of determinations on the necessity of the intellectual property rights as training data, it is possible to determine the necessity of intellectual property rights appropriately based on various kinds of evaluation data on intellectual property rights.

(Sixteenth Item) An evaluation program for causing a computer to perform functions including: an evaluation-data acquisition unit that acquires evaluation data on a target intellectual property right which is an intellectual property right to be evaluated; an evaluation model generated by machine learning using evaluation data on intellectual property rights and results of determinations on the necessity of the intellectual property rights as training data; and a necessity determination unit that determines, by using the evaluation model, the necessity of the target intellectual property right on which the evaluation data is acquired by the evaluation-data acquisition unit.

By executing the evaluation program according to the sixteenth item on a computer, it is possible to build the configuration of the evaluation system of intellectual property rights according to the first item.

(Seventeenth Item) Correction data used for correction of an evaluation model that is generated by machine learning using evaluation data on intellectual property rights and results of determinations on the necessity of the intellectual property rights as training data and that receives input of the evaluation data and outputs necessity determination data indicating the necessity, the correction data including: evaluation data on a target intellectual property right which is an intellectual property right to be evaluated, the evaluation data being generated in a case in which the evaluation data on the target intellectual property right is input to the evaluation model, the necessity determination data indicating “unnecessary” is output, and a person in charge of intellectual properties determines the target intellectual property right to be necessary; and a determination result that the target intellectual property right is necessary.

By performing machine learning using the correction data according to the Seventeenth item as training data, it is possible to improve accuracy in the necessity determination on intellectual property rights by the evaluation model.

### REFERENCE SIGNS LIST

1 evaluation system of intellectual property rights
10 processor
11 AI platform
11b evaluation model
12 evaluation-model generation unit
13 evaluation-data acquisition unit
14 necessity determination unit
15 first additional-determination-data acquisition unit
16 first evaluation-model correction unit
17 maintenance-cost calculation unit
18 maintenance-cost examination unit
19 second additional-determination-data acquisition unit
20 second evaluation-model correction unit
30 storage unit
31 evaluation program
32 AI platform program
33 training data set
34 correction data set
100 terminal for a person in charge of IP
200 intellectual-property-right management server
210 management DB
P person in charge of IP

1. An evaluation system of intellectual property rights comprising:
an evaluation-data acquisition unit that acquires evaluation data on a target intellectual property right which is an intellectual property right to be evaluated;
an evaluation model generated by machine learning using evaluation data on intellectual property rights and results of determinations on the necessity of the intellectual property rights as training data;
a necessity determination unit that determines, by using the evaluation model, the necessity of the target intellectual property right on which the evaluation data is acquired by the evaluation-data acquisition unit; and
an evaluation-model generation unit that generates the evaluation model by machine learning in which determination accuracy for “unnecessary” is prioritized over determination accuracy for “necessary” or machine learning in which determination accuracy for “necessary” is prioritized over determination accuracy for “unnecessary”.

2. The evaluation system of intellectual property rights according to claim 1, further comprising:
a first additional-determination-data acquisition unit that acquires first additional-determination data indicating a necessity determination result by a person in charge on the target intellectual property right determined to be unnecessary by the necessity determination unit; and
a first evaluation-model correction unit that, in a case in which the first additional-determination data indicates “necessary”, corrects the evaluation model by machine learning using first correction data as training data, the first correction data including the evaluation data on the target intellectual property right and a determination result that the target intellectual property right is necessary.

3. The evaluation system of intellectual property rights according to claim 2, wherein:
in a case in which the first additional-determination data indicates “unnecessary”, the first evaluation-model correction unit corrects the evaluation model by machine learning using the first correction data and second correction data as training data with a larger weight assigned to the first correction data than to the second correction data, the second correction data including the evaluation data on the target intellectual property right and a determination result that the target intellectual property right is unnecessary.

4. The evaluation system of intellectual property rights according to claim 2, wherein
the target intellectual property right is one of a plurality of target intellectual property rights, and
the first evaluation-model correction unit repeats correction of the evaluation model until the first additional-determination data on the target intellectual property right determined to be unnecessary by the necessity determination unit satisfies a predetermined condition.

5. The evaluation system of intellectual property rights according to claim 1, further comprising:
a second additional-determination-data acquisition unit that acquires second additional-determination data indicating a necessity determination result by a person in charge on the target intellectual property right determined to be necessary by the necessity determination unit; and
a second evaluation-model correction unit that, in a case in which the second additional-determination data indicates “unnecessary”, corrects the evaluation model by machine learning using third correction data as training data, the third correction data including the evaluation data on the target intellectual property right and a determination result that the target intellectual property right is unnecessary.

6. The evaluation system of intellectual property rights according to claim 5, wherein:
in a case in which the second additional-determination data indicates “necessary”, the second evaluation-model correction unit corrects the evaluation model by machine learning using the third correction data and fourth correction data as training data with a larger weight assigned to the third correction data than to the fourth correction data, the fourth correction data including the evaluation data on the target intellectual property right and a determination result that the target intellectual property right is necessary.

7. The evaluation system of intellectual property rights according to claim 5, wherein
the target intellectual property right is one of a plurality of target intellectual property rights, and
the second evaluation-model correction unit repeats correction of the evaluation model until the second additional-determination data on the target intellectual property right determined to be necessary by the necessity determination unit satisfies a predetermined condition.

8. The evaluation system of intellectual property rights according to claim 1, further comprising:
a maintenance-cost calculation unit that calculates the maintenance cost of the intellectual property rights determined to be necessary by the necessity determination unit; and
a maintenance-cost examination unit that compares the cost calculated by the maintenance-cost calculation unit with a specified budget.

9. The evaluation system of intellectual property rights according to claim 8:
the evaluation model outputs necessity determination data indicating the confidence level of the necessity along with the necessity of the intellectual property right, and
in a case in which the necessity determination unit recognizes that the maintenance cost exceeds the budget as a result of comparison by the maintenance-cost examination unit, the necessity determination unit makes a notification of the target intellectual property rights the confidence levels of which are smaller than or equal to a third specified value, out of the target intellectual property rights determined to be necessary, or the necessity determination unit changes the necessity determination to “unnecessary” from the target intellectual property right having a lower confidence level out of the target intellectual property rights determined to be necessary so that the maintenance cost becomes within the budget.

10. The evaluation system of intellectual property rights according to claim 8, wherein:
the evaluation model outputs necessity determination data indicating the confidence level of the necessity along with the necessity of the intellectual property right, and
in a case in which the necessity determination unit recognizes that the maintenance cost is below the budget as a result of comparison by the maintenance-cost examination unit, the necessity determination unit makes a notification of the target intellectual property rights the confidence levels of which are smaller than or equal to a fourth specified value, out of the target intellectual property rights determined to be unnecessary, or the necessity determination unit changes the necessity determination to “necessary” from the target intellectual property right having a lower confidence level out of the target intellectual property rights determined to be unnecessary, within a range in which the maintenance cost is lower than or equal to the budget.

11. The evaluation system of intellectual property rights according to claim 1, wherein
the evaluation data includes an evaluation result of an item indicating the importance of the intellectual property right.

12. The evaluation system of intellectual property rights according to claim 1, wherein:
the evaluation data includes a budget amount available to hold the intellectual property right.

13. The evaluation system of intellectual property rights according to claim 1, wherein
the evaluation data includes at least one of a technical field to which the intellectual property right belongs, the state of the ownership of the intellectual property right in a plurality of countries, the ownership cost of the intellectual property right, the remaining period of the intellectual property right, whether the intellectual property right has been implemented or not by the owner of the intellectual property right or the possibility of implementing the intellectual property right by the owner of the intellectual property right, and whether the intellectual property right is licensed to others, or the possibility of licensing the intellectual property right to others.

14. An evaluation method of intellectual property rights executed by a computer, comprising:
an evaluation-data acquisition step of acquiring evaluation data on a target intellectual property right which is an intellectual property right to be evaluated;
a necessity determination step of determining the necessity of the target intellectual property right on which the evaluation data is acquired in the evaluation-data acquisition step, by using an evaluation model generated by machine learning using evaluation data on intellectual property rights and results of determinations on the necessity of the intellectual property rights as training data; and
an evaluation-model generation step of generating the evaluation model by machine learning in which determination accuracy for “unnecessary” is prioritized over determination accuracy for “necessary” or machine learning in which determination accuracy for “necessary” is prioritized over determination accuracy for “unnecessary”.

15. A non-transitory computer-readable storage medium comprising:
an evaluation-data acquisition unit that acquires evaluation data on a target intellectual property right which is an intellectual property right to be evaluated;
an evaluation model generated by machine learning using evaluation data on intellectual property rights and results of determinations on the necessity of the intellectual property rights as training data;
a necessity determination unit that determines, by using the evaluation model, the necessity of the target intellectual property right on which the evaluation data is acquired by the evaluation-data acquisition unit; and
an evaluation-model generation unit that generates the evaluation model by machine learning in which determination accuracy for “unnecessary” is prioritized over determination accuracy for “necessary” or machine learning in which determination accuracy for “necessary” is prioritized over determination accuracy for “unnecessary”.

16-17. (canceled)
